(19) United States
(12) Patent Application Publication
(10) Pub. No.: US 2020/0033546 A1
(43) Pub. Date: Jan. 30, 2020

(54) OPTICAL FIBER MANAGEMENT TRAY WITH OVER-THE-CENTER PERFORMANCE FOR ENHANCED OPTICL FIBER ACCESSIBILITY

(71) Applicant: COMMSCOPE CONNECTIVITY BELGIUM BVBA, Kessel-Lo (BE)

(72) Inventors: Johan GEENS, Bunsbeek (BE); Bart VOS, Geel (BE)

(73) Assignee: COMMSCOPE CONNECTIVITY BELGIUM BVBA, Kessel-Lo (BE)

(21) Appl. No.: 16/500,879

(22) PCT Filed: Apr. 4, 2018
(86) PCT No.: PCT/EP2018/058564

§ 371 Date: Oct. 4, 2019

Related U.S. Application Data
(60) Provisional application No. 62/481,249, filed on Apr. 4, 2017.

(51) Int. Cl. G02B 6/44

(52) U.S. Cl. CPC G02B 6/4455

(57) ABSTRACT

Aspects and techniques of the present disclosure relate to an example telecommunications optical fiber management tray that provides unobstructed access to the example telecommunications optical fiber management tray for handling optical fibers thereon. The example telecommunications optical fiber management tray can include an over-the-center action in a flex/detent mechanism inherently formed within the example telecommunications optical fiber management tray. The over-the-center action allows the multi-stable flexible base to move between the stable non-deflected position and the stable deflected position. When the multi-stable flexible base is in the stable deflected position, a plurality of tabs positioned about a periphery of the multi-stable flexible base is maintained in an open position to provide enhanced access for loading and removing optical fiber. When the multi-stable flexible base is in the stable non-deflected position, the plurality of tabs is maintained in a closed position to retain the optical fiber thereon.

### CROSS-REFERENCE TO RELATED APPLICATION

This application claims the benefit of U.S. Patent Application Serial No. 62/481,249, filed on Apr. 4, 2017, the disclosure of which is incorporated herein by reference in its entirety.

### TECHNICAL FIELD

The present disclosure relates generally to telecommunications management devices. More particularly, the present disclosure relates to fiber management trays for managing optical fibers.

### BACKGROUND

Optical fiber distribution systems may include equipment such as fiber management trays that are mounted in telecommunications closures or at other locations. Fiber management trays are commonly used to manage, store and protect optical fibers and optical splices. Fiber management trays include fiber routing paths for allowing excess length of optical fiber to be stored in looped configurations without violating minimum bend radius requirements for the optical fiber. Fiber management trays typically include fiber guide structures that define the fiber routing paths and splice storage locations. Fiber optic components such as fiber optic fusion splice holders, passive optical splitters and wavelength division multiplexers are often mounted to fiber management trays. Improvements in fiber management trays are needed for optical fiber accessibility and handling.

### SUMMARY

One aspect of the present disclosure relates to a telecommunications optical fiber management tray. The tray can include a main body with a multi-stable flexible base that defines a storage region for storing optical fiber. The multi-stable flexible base can be resiliently flexible between a stable non-deflected position and a stable deflected position. The tray can include a fiber containment wall that extends upwardly from the multi-stable flexible base. The fiber containment wall can define portions of a perimeter of the main body of the tray that surrounds the multi-stable flexible base. The tray can further include a plurality of tabs that extend from the fiber containment wall. Deformation of the tray deforms the main body of the tray from the stable non-deflected position to the stable deflected position. When the tray is in the stable deflected position, each one of the plurality of tabs can be maintained in an open position where access to the storage region of the multi-stable flexible base is provided for adding optical fiber. Deformation of the tray can deform the main body of the tray from the stable deflected position to the stable non-deflected position. When the tray is in the stable non-deflected position, each one of the plurality of tabs can be maintained in a closed position where the plurality of tabs move away from the storage region as the plurality of tabs move from the closed position toward the open position and the plurality of tabs move toward the storage region as the plurality of tabs move from the open position toward the closed position.

Another aspect of the present disclosure relates to a fiber management tray. The fiber management tray can include a multi-stable flexible base resiliently flexible between a stable non-deflected position and a stable deflected position. The fiber management tray can include cable management elements positioned about a periphery of the fiber management tray; and a flex mechanism inherently formed within the multi-stable flexible base of the tray to provide an over-the-center action. The over-the-center action can allow the multi-stable flexible base to move between the stable non-deflected position and the stable deflected position. Deformation of the tray can deform the fiber management tray from the stable non-deflected position to the stable deflected position. When the fiber management tray is in the stable deflected position, each one of the cable management elements can be maintained in an open position where access to the multi-stable flexible base is provided for adding and removing optical fiber. Deformation of the fiber management tray can also deform the fiber management tray from the stable deflected position to the stable non-deflected position. When the fiber management tray is in the stable non-deflected position, each one of the cable management elements can be maintained in a closed position to retain optical fibers on the fiber management tray.

A variety of additional aspects will be set forth in the description that follows. The aspects relate to individual features and to combinations of features. It is to be understood that both the foregoing general description and the following detailed description are exemplary and explanatory only and are not restrictive of the broad inventive concepts upon which the embodiments disclosed herein are based.

### BRIEF DESCRIPTION OF THE DRAWINGS

The accompanying drawings, which are incorporated in and constitute a part of the description, illustrate several aspects of the present disclosure. A brief description of the drawings is as follows:

FIG. 1 is a top perspective view of an example telecommunications optical fiber management tray including a storage region and a plurality of tabs in an open position in accordance with the principles of the present disclosure;

FIG. 2 is a top perspective view of the example telecommunications optical fiber management tray shown in FIG. 1 with the plurality of tabs in a closed position in accordance with the principles of the present disclosure;

FIGS. 3A and 3B are schematically cross-sectional views of the telecommunications optical fiber management tray shown in FIG. 1 depicting an over-the-center action in accordance with the principles of the present disclosure;

FIG. 4A is perspective view of the telecommunications optical fiber management tray of FIG. 1 shown mounted to a structure with the plurality of tabs in an open position in accordance with the principles of the present disclosure; and

FIG. 4B is perspective view of the telecommunications optical fiber management tray of FIG. 1 shown mounted to the structure of FIG. 4A with the plurality of tabs in a closed position in accordance with the principles of the present disclosure.

### DETAILED DESCRIPTION

Reference will now be made in detail to the exemplary aspects of the present disclosure that are illustrated in the accompanying drawings. Wherever possible, the same reference numbers will be used throughout the drawings to refer to the same or like structure.

The present disclosure relates to an advantageous example telecommunications optical fiber management tray adapted to be used within a telecommunications enclosure, closure, box, cabinet, terminal or at any other location where fiber management is desirable. The example telecommunications optical fiber management tray can include an over-the-center action in a flex/detent mechanism inherently formed within the example telecommunications optical fiber management tray. The flex/detent mechanism can be generally formed within a center region of the example telecommunications optical fiber management tray. The over-the-center action allows the multi-stable flexible base to move between a stable non-deflected position and a stable deflected position.

When the multi-stable flexible base is in the stable deflected position, a plurality of tabs positioned about a periphery of the multi-stable flexible base is maintained in an open position to provide enhanced access for loading and removing optical fiber. When the multi-stable flexible base is in the stable non-deflected position, the plurality of tabs is maintained in a closed position to retain the optical fiber thereon.

Each one of the plurality of tabs moves between the open and closed positions as the deformation of the multi-stable flexible base causes the multi-stable flexible base to flex/detent between the stable non-deflected and stable deflected positions. The advantageous optical fiber management tray provides for a flexible, easy access, arrangement for storing optical fibers.

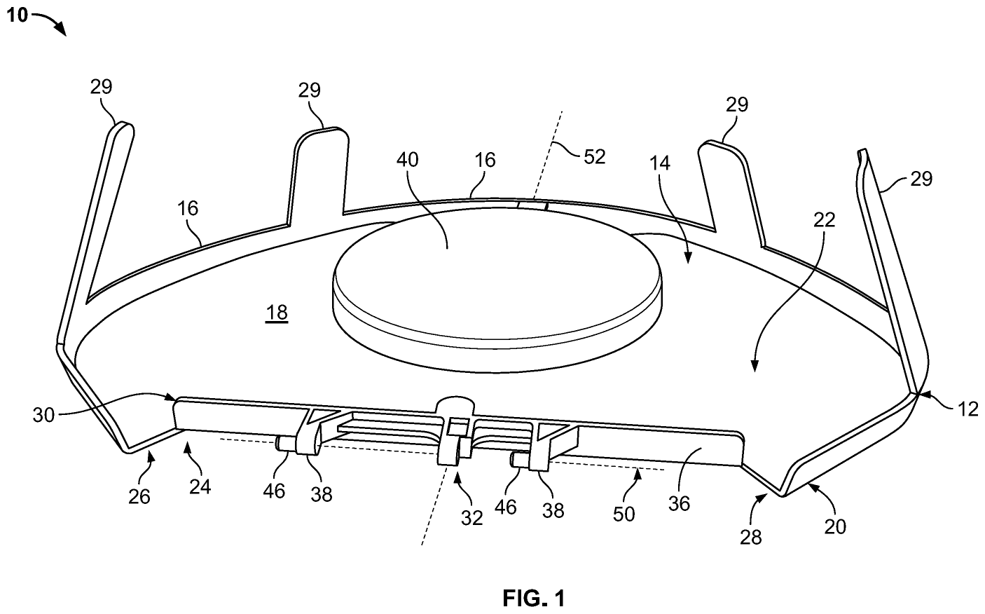

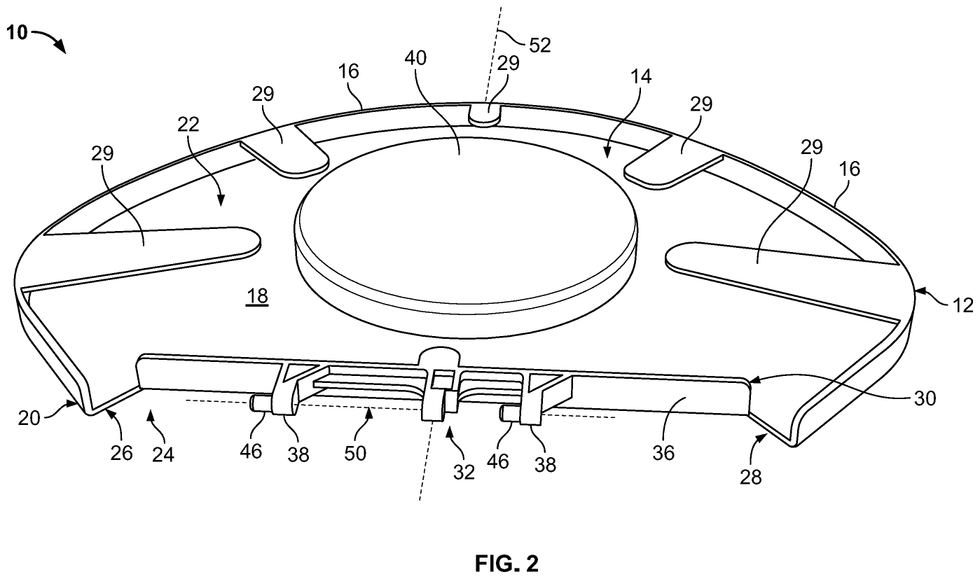

FIGS. 1-2 illustrate perspective top views of an example telecommunications optical fiber management tray 10. It should be noted that the example telecommunications optical fiber management tray 10 can be a splice-only tray, splitter tray, combinations thereof, or house equipment having other functions. The example telecommunications optical fiber management tray 10 includes a main body 12 that has a multi-stable flexible base 14, and a fiber containment wall 16. In the example depicted, the fiber containment wall 16 extends upwardly from a top surface 18 of the multi-stable flexible base 14 to define portions of a periphery 20 of the main body 12 of the example telecommunications optical fiber management tray 10 that surrounds the multi-stable flexible base 14. In other examples, there may be more than one fiber containment wall 16 positioned on the main body 12 of the example telecommunications optical fiber management tray 10. In the example shown, the fiber containment wall 16 is curved, although alternatives are possible. In one example, the fiber containment wall 16 can function as fiber guides and have curvatures compatible with minimum bend radius requirements of the fibers intended to be managed on the example telecommunications optical fiber management tray 10.

The example multi-stable flexible base 14 includes a flex/detent mechanism that provides an over-the-center action to allow the multi-stable flexible base 14 to be resiliently flexible between a stable non-deflected position (see FIG. 2) and a stable deflected position (see FIG. 1). The multi-stable flexible base 14 also defines a storage region 22 for storing slack or loops of optical fiber thereon. Various structures can be provided in the storage region 22 including splices and/or storage of cables, which will be described below. Various additional structures can be provided for managing and organizing fiber optic cables, including a divider wall and cable retention tabs, which is further described below.

The multi-stable flexible base 14 of the main body 12 is shown as including a generally flat body of a suitably resilient plastic or polymeric material, although alternatives are possible. According to some examples, the example telecommunications optical fiber management tray 10 may be formed of a polymeric material, such as, polypropylene, polyethylene, nylon, ABS, PMMA, some other material or any combination thereof. In other examples, the example telecommunications optical fiber management tray 10 may be formed of any suitable rigid or semi-rigid material.

The main body 12 of the example telecommunications optical fiber management tray 10 may define an opening 24 (e.g., cut-out, notch) in the multi-stable flexible base 14. The opening 24 can be defined by a first end 26 of the multi-stable flexible base 14 and a second end 28 of the multi-stable flexible base 14, although alternatives are possible. For example, the opening 24 can extend between the first and second ends 26, 28 of the multi-stable flexible base 14.

The example telecommunications optical fiber management tray 10 can further include a sidewall 30. The sidewall 30 is positioned along the opening 24 of the multi-stable flexible base 14 to define a side of the opening 24, although alternatives are possible. As depicted, the sidewall 30 extends upwardly from a portion of the multi-stable flexible base 14 along the opening 24 defined by the first and second ends 26, 28 of the multi-stable flexible base 14.

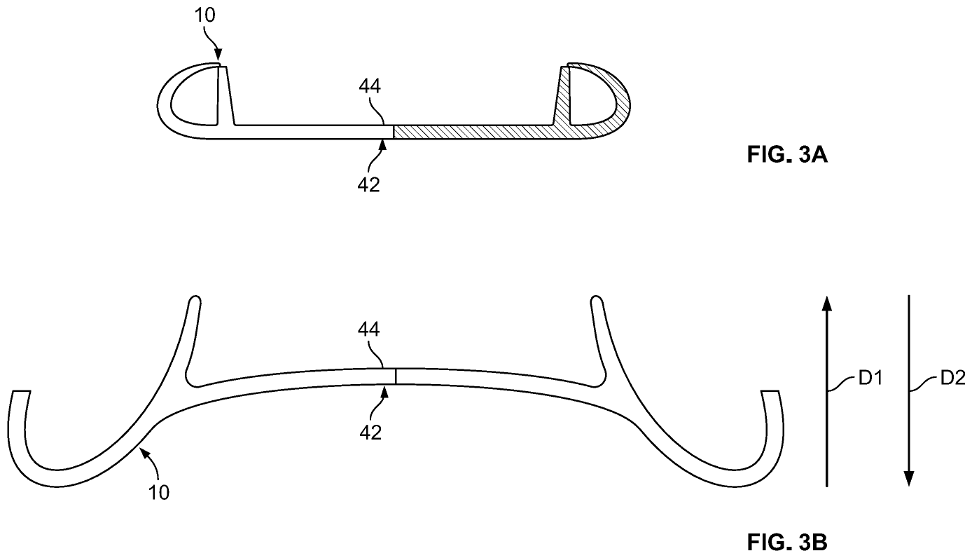

The sidewall 30 is arranged and configured with a mechanical coupling interface 32 (e.g., a hinge mechanism, pivot mounts) to couple the example telecommunications optical fiber management tray 10 to a structure 34 (see FIG. 3) (e.g., a tray mounting plate, a fiber optic terminal, a fiber optic splice terminal, or other type of housing/enclosure). The mechanical coupling interface 32 may also be a snap-fit, an interference fit, and/or a press-fit, although alternatives are possible.

The mechanical coupling interface 32 is arranged and configured on an outer surface 36 of the sidewall 30 facing toward the opening 24 of the multi-stable flexible base 14, although alternatives are possible. The mechanical coupling interface 32 includes hinge members 38 that are attached to the sidewall 30 to pivotally connect the example telecommunications optical fiber management tray 10 to the structure 34. The mechanical coupling interface 32 allows the example telecommunications optical fiber management tray 10 to rotate or pivot upwardly or downwardly at an angle with respect to a plane of the structure 34.

Although two hinge members 38 are shown, any number of hinges may be used. Additionally or alternatively, any mechanism or design that provides or allows for a pivoting or tilting action of the example telecommunications optical fiber management tray 10 with respect to the structure 34 may be employed. Such mechanism or design may include for example a hinge that is constructed of the same or different material as the structure 34 and/or example telecommunications optical fiber management tray 10. The hinge members 38 may be made of a lightweight, structurally flexible material, such as a polymeric material or molded plastic, although alternatives are possible.

Additionally, the mechanical coupling interface 32 may be formed as an integral portion of one or both of the structure 34 and/or example telecommunications optical fiber management tray 10. In other examples, the example telecommunications optical fiber management tray 10 may be secured to the structure 34 by clamps, latches, straps or any other suitable mechanism, such as, capture arms, although alternatives are possible.

The top surface 18 of the multi-stable flexible base 14 of the example telecommunications optical fiber management tray 10 is configured for storing, protecting, and routing optical fiber. For example, the top surface 18 can include structure that defines one or more fiber routing paths. In certain examples, the fiber routing paths can define one or more fiber loops. In certain examples, the fiber routing paths can include a fiber management loop that is routed along the periphery 20 of the main body 12 of the example telecommunications optical fiber management tray 10.

Turning again to FIGS. 1 and 2, the example telecommunications optical fiber management tray 10 further includes a radius limiter 40 (e.g., fiber routing guide) that is positioned on the top surface 18 of the multi-stable flexible base 14 in the storage region 22 for storing optical fiber. The radius limiter 40 projects upwardly from the top surface 18 of the multi-stable flexible base 14 and cooperates to define a protected fiber management path (e.g., a fiber management loop) at the top surface 18 of the multi-stable flexible base 14. The radius limiter 40 is constructed to limit the bend radius of cables when the cables are wrapped about the limiters for storage and/or organizational purposes. The radius limiter 40 can also assist and retain optical fibers in a looped configuration.

In the example depicted, one radius limiter 40 is shown on the multi-stable flexible base 14. Although one radius limiter 40 is shown, no fiber routing guides, one fiber routing guides, or any number of fiber routing guides may be used. In one example, the radius limiter 40 may be monolithically formed with the multi-stable flexible base 14 to define a one-piece unit, although alternatives are possible.

In certain examples, at least one inner fiber guide wall (not shown) may be used as a fiber routing guide on the example telecommunications optical fiber management tray 10. The inner fiber guide wall can project upwardly from the top surface 18 of the multi-stable flexible base 14, although multiple inner fiber guide walls may be used.

In one example, the example telecommunications optical fiber management tray 10 may include a splice holding element (not shown) for securing a plurality of fiber optic splices. The splice holding element can be provided to hold splice sleeves that protect fusion splices between drop cables and fibers of a through cable. In one example, the splice holding element can be adapted for in-line splicing. The multi-stable flexible base 14 of the example telecommunications optical fiber management tray 10 may also include other routing transition structures for transitioning optical fibers.

During manufacture of the example telecommunications optical fiber management tray 10, the splice holding element can be molded with the multi-stable flexible base 14 so that the splice holding element and the multi-stable flexible base 14 are integral. That is, the splice holding element is not attachable or detachable from the multi-stable flexible base 14; rather, the example telecommunications optical fiber management tray 10 is constructed such that the multi-stable flexible base 14 and the splice holding element are a one-piece unit, although alternatives are possible.

The example telecommunications optical fiber management tray 10 can include cable management elements 29 for holding incoming cables or optical fibers inside the example telecommunications optical fiber management tray 10. The cable management elements 29 can include hooks, fingers, tabs, ties, and other devices for guiding and managing cables or optical fibers. In certain examples, the cable management elements 29 can include one or more pivoting components. In one example, the cable management elements 29 can be positioned along the fiber containment wall 16 of the example telecommunications optical fiber management tray 10 and generally extend over the top surface 18 of the multi-stable flexible base 14 to retain optical fiber. That is, the cable management elements 29 can extend from the fiber containment wall 16 in a direction toward the radius limiter 40 when in a closed position (see FIG. 2). For example, the cable management elements 29 can project from the fiber containment wall 16 and oppose the top surface 18. The cable management elements 29 can be positioned around the periphery 20 of the main body 12 of the example telecommunications optical fiber management tray 10 for holding down or retaining the optical fibers. That is, the cable management elements 29 can retain cables or optical fibers about the radius limiter 40 and also retain cables and optical fibers within the storage region 22 of the example telecommunications optical fiber management tray 10.

Referring to FIGS. 3A and 3B, a schematic cross-sectional side view of the example telecommunications optical fiber management tray 10 is depicted. The example telecommunications optical fiber management tray 10 can be formed from an elastically deformable material such that deformation of the multi-stable flexible base 14 deforms the main body 12 of the example telecommunications optical fiber management tray 10 between a stable non-deflected position (see FIG. 3A) and a stable deflected position (see FIG. 3B). That is, the example telecommunications optical fiber management tray 10 includes an over-the-center action in a flex/detent mechanism 42 inherently formed within the example telecommunications optical fiber management tray 10. The flex/detent mechanism 42 can be generally formed within a center region 44 of the example telecommunications optical fiber management tray 10. The over-the-center action allows the multi-stable flexible base 14 to move between the stable non-deflected position and the stable deflected position.

When the example telecommunications optical fiber management tray 10 is progressively bent, flexed, or deformed from the stable non-deflected position to the stable deflected position, a center region 44 of the example telecommunications optical fiber management tray 10 bends, flexes, or deforms from a generally flat orientation (see FIG. 3A) to a generally bowed or bent orientation (see FIG. 3B). When the example telecommunications optical fiber management tray 10 is progressively bent, flexed, or deformed from the stable deflected position to the stable non-deflected position, the center region 44 of the example telecommunications optical fiber management tray 10 bends, flexes, or deforms from the generally bowed or bent orientation (see FIG. 3B) to the generally flat orientation (see FIG. 3A).

Although the example telecommunications optical fiber management tray 10 is not stable while the flex/detent mechanism 42 is actuated to create the over-the-center action between configurations of the stable non-deflected position and the stable deflected position, the example telecommunications optical fiber management tray 10 is adapted and configured to be stable once in the stable non-deflected position or in the stable deflected position. That is, while the example telecommunications optical fiber management tray 10 is in the stable non-deflected position, the example telecommunications optical fiber management tray 10 is not flexed, bent, and/or deformed back to the stable deflected position, inadvertently. Also, while the example telecommunications optical fiber management tray 10 is in the stable deflected position, the example telecommunications optical fiber management tray 10 is not flexed, bent, and/or deformed to the stable non-deflected position, inadvertently.

In certain examples, deformation of the example telecommunications optical fiber management tray 10 deforms the main body 12 of the example telecommunications optical fiber management tray 10 between the stable non-deflected position and the stable deflected position. When the example telecommunications optical fiber management tray 10 is moved from the non-deflected position to the stable deflected position, each one of cable management elements 29 are moved and maintained in an open position (see FIG. 1).

In certain examples, the cable management elements 29 are monolithically formed with the example telecommunications optical fiber management tray 10 such that each one of the cable management elements 29 is moveable with the example telecommunications optical fiber management tray 10 upon deformation. That is, the cable management elements 29 are arranged and configured to move from a closed position (see FIG. 2) to the open position (see FIG. 1) as the flex/detent mechanism 42 of the example telecommunications optical fiber management tray 10 is actuated generally in a first direction D₁ to create the over-the-center action and cause the example telecommunications optical fiber management tray 10 to deform. The over-the-center action can create a bend or bow in the example telecommunications optical fiber management tray 10 to allow the example telecommunications optical fiber management tray 10 to move from the stable non-deflected position to the stable deflected position.

When the cable management elements 29 are in the open position, easier access can be provided to the storage region 22 of the multi-stable flexible base 14 for adding or removing optical fiber from the example telecommunications optical fiber management tray 10. While the cable management elements 29 are in the open position, a user can have easier access to optical fibers stored or managed on the example telecommunications optical fiber management tray 10 with limited or zero interference with the cable management elements 29. That is, by allowing the cable management elements 29 to be in the open position, unobstructed access can be obtained to the optical fibers on the example telecommunications optical fiber management tray 10.

When the flex/detent mechanism 42 of the example telecommunications optical fiber management tray 10 is actuated or pushed generally in a second direction D₂ to again create the over-the-center action, the example telecommunications optical fiber management tray 10 can be moved from the stable deflected position to the stable non-deflected position. Each one of cable management elements 29 can be arranged and configured to move from the open position to the closed position as the flex/detent mechanism 42 of the example telecommunications optical fiber management tray 10 is actuated generally in the second direction D₂. When the cable management elements 29 are in the closed position, the cable management elements 29 can extend in a direction toward the radius limiter 40 and the storage region 22 of the multi-stable flexible base 14 to retain optical fibers positioned on the example telecommunications optical fiber management tray 10.

The cable management elements 29 can be constructed of the same or different material as the example telecommunications optical fiber management tray 10. The cable management elements 29 may be made of a lightweight, structurally flexible material, such as a polymeric material or molded plastic, although alternatives are possible. Additionally, the cable management elements 29 may be formed as an integral portion of the fiber containment wall 16, although alternatives are possible.

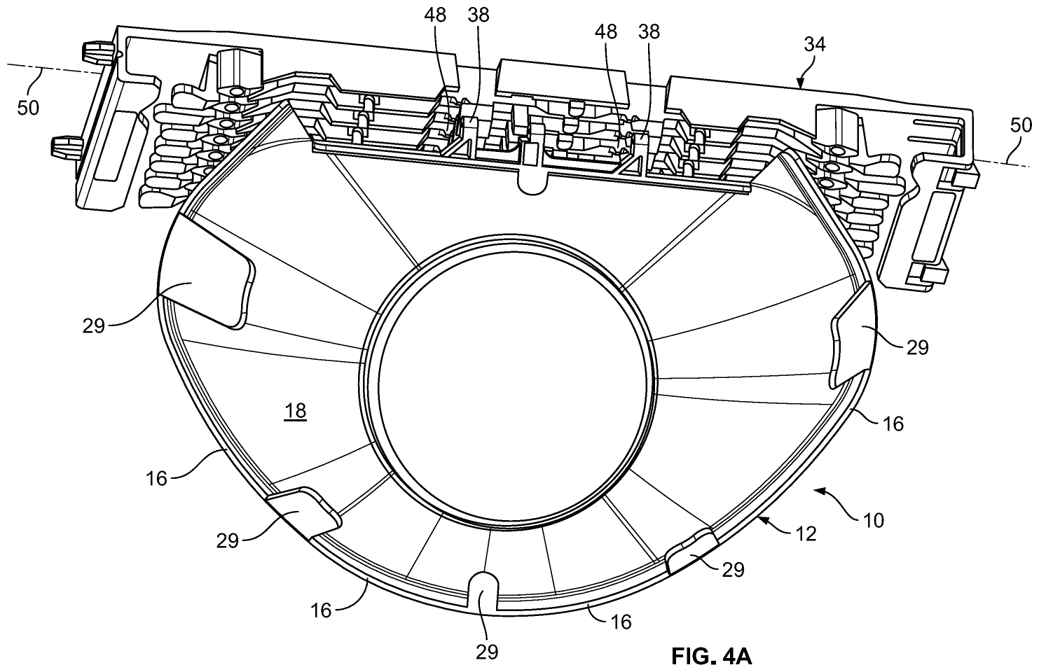

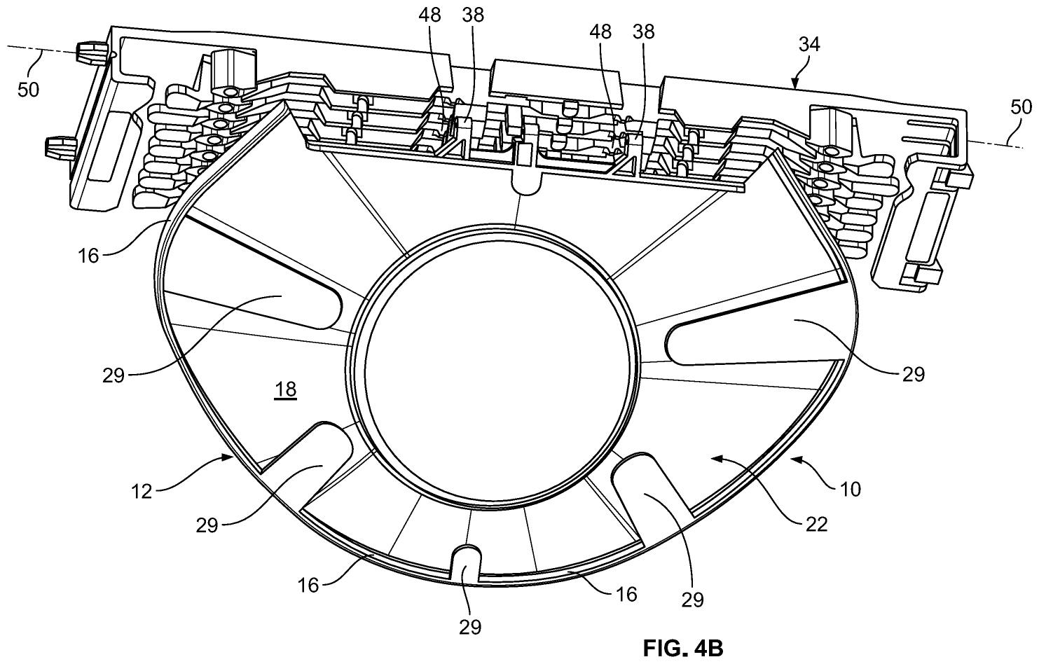

Referring to FIGS. 4A and 4B, in this example, the example telecommunications optical fiber management tray 10 is depicted coupled to the structure 34. Although one example telecommunications optical fiber management tray 10 is shown, it will be appreciated that multiple trays may be used and stacked in groups or blocks to form a stacked arrangement. The stacked trays may be assembled in known or other suitable manner. For example, the trays can be pivotally mounted on the structure 34 to cantilever therefrom, although alternatives are possible. In one example, the trays may be staggered vertically as mounted on the structure 34, although alternatives are possible. In other examples, the trays may be stacked horizontally, although alternatives are possible.

Hinge members 38 can include snap-in pivot devices 46 (see FIGS. 1-2) (e.g., pivot pins, pivot rods). The snap-in pivot devices 46 can be configured to engage, for example, clips 48 positioned on the structure 34. The clips 48 can be configured to hold the snap-in pivot devices 46. The snap-in pivot devices 46 can pivot within the clips 48 of the structure 34 to allow the example telecommunications optical fiber management tray 10 to swing out individually for accessing optical fiber on the example telecommunications optical fiber management tray 10. In other examples, the snap-in pivot devices 46 and clips 48 may be reversed such that the snap-in pivot devices 46 are configured on the structure 34 and the clips 48 are configured on the mechanical coupling interface 32.

The hinge members 38 can have a hinge axis 50 (see FIGS. 1-2) that is perpendicular to a tray axis 52 (see FIGS. 1-2). The example telecommunications optical fiber management tray 10 is adapted to pivot around the hinge axis 50. In certain examples, lower ones of the trays in a stack can be accessed without removal of superposed trays. One end of the stack can be lifted upwardly or pivoted. After work within that tray is completed, it can be returned to its located position in the stack merely by reversing the procedure.

The example telecommunications optical fiber management tray 10 may include, for example, fiber guides, a splice/termination holder, and may include one or more pivoting components. The example telecommunications optical fiber management tray 10 can include fiber routing paths for routing excess fiber in looped configurations that prevent the fibers from being bent beyond their minimum bend radius requirements. Additionally, the example telecommunications optical fiber management tray 10 can retain and protect fiber optic components such as passive optical splitters and/or wavelength division multiplexors.

In certain examples, fiber management trays in accordance with the principles of the present disclosure can include structures for mounting optical fiber splices and/or passive optical components on major sides of the trays. In other examples, outputs of optical components can be routed to the tray for splicing to cables. Outputs of the optical component can also be spliced to optical fibers for forward feeding and/or back feeding signals through the main fiber optic cable.

From the forgoing detailed description, it will be evident that modifications and variations can be made without departing from the spirit and scope of the disclosure.

What is claimed is:

1. A telecommunications tray, comprising:
a main body including a multi-stable flexible base defining a storage region for storing optical fiber, the multi-stable flexible base being resiliently flexible between a stable non-deflected position and a stable deflected position;
a fiber containment wall extending upwardly from the multi-stable flexible base, the fiber containment wall defining portions of a perimeter of the main body of the telecommunications tray that surrounds the multi-stable flexible base;
a plurality of tabs extending from the fiber containment wall;
wherein deformation of the telecommunications tray deforms the main body of the telecommunications tray from the stable non-deflected position to the stable deflected position, when the telecommunications tray is in the stable deflected position, each one of the plurality of tabs being maintained in an open position, and wherein access to the storage region of the multi-stable flexible base is provided for adding optical fiber;
wherein deformation of the telecommunications tray deforms the main body of the telecommunications tray from the stable deflected position to the stable non-deflected position, when the telecommunications tray is in the stable non-deflected position, each one of the plurality of tabs being maintained in a closed position;
wherein the plurality of tabs move away from the storage region as the plurality of tabs move from the closed position toward the open position; and
wherein the plurality of tabs move toward the storage region as the plurality of tabs move from the open position toward the closed position.

2. The telecommunications tray of claim 1, wherein each one of the plurality of tabs is monolithically formed with the telecommunications tray such that each one of the plurality of tabs is moveable with the telecommunications tray upon deformation.

3. The telecommunications tray of claim 1, wherein the multi-stable flexible base of the telecommunications tray defines an opening that extends from a first end of the multi-stable flexible base toward a second end of the multi-stable flexible base.

4. The telecommunications tray of claim 3, further comprising a sidewall positioned in the opening of the multi-stable flexible base to define a side of the opening, the sidewall extending upwardly from a portion of the multi-stable flexible base along the opening defined by the first and second ends of the multi-stable flexible base.

5. The telecommunications tray of claim 4, wherein the sidewall includes a mechanical coupling interface to couple the telecommunications tray to a structure.

6. The telecommunications tray of claim 5, wherein the mechanical coupling interface includes hinge members that are attached to the sidewall to pivotally connect the telecommunications tray to the structure.

7. The telecommunications tray of claim 1, wherein the telecommunications tray further includes a radius limiter positioned in the storage region of the multi-stable flexible base for storing fiber optic cable.

8. The telecommunications tray of claim 7, wherein the radius limiter is monolithically formed with the multi-stable flexible base to define a one-piece unit.

9. The telecommunications tray of claim 1, further comprising at least one splice holding element positioned on the multi-stable flexible base of the telecommunications tray for securing a plurality of fiber optic splices.

10. The telecommunications tray of claim 9, wherein the at least one splice holding element is adapted for in-line splicing.

11. The telecommunications tray of claim 1, wherein the telecommunications tray is formed from an elastically deformable material.

12. A fiber management tray comprising:
a multi-stable flexible base resiliently flexible between a stable non-deflected position and a stable deflected position;
cable management elements positioned about a periphery of the fiber management tray; and
a flex mechanism inherently formed within the multi-stable flexible base of the fiber management tray to provide an over-the-center action, the over-the-center action allowing the multi-stable flexible base to move between the stable non-deflected position and the stable deflected position;
wherein deformation of the fiber management tray deforms the fiber management tray from the stable non-deflected position to the stable deflected position, when the fiber management tray is in the stable deflected position, each one of the cable management elements being maintained in an open position, and wherein access to the multi-stable flexible base is provided for adding and removing optical fiber; and
wherein deformation of the fiber management tray deforms the fiber management tray from the stable deflected position to the stable non-deflected position, when the fiber management tray is in the stable non-deflected position, each one of the cable management elements being maintained in a closed position.

13. The fiber management tray of claim 12, wherein the cable management elements extend in a direction toward a storage region defined by the multi-stable flexible base to retain optical fiber positioned therein.

14. The fiber management tray of claim 12, wherein the flex mechanism is generally formed within a center region of the tray.

15. The fiber management tray of claim 12, wherein the cable management elements are monolithically formed with the fiber management tray such that each one of the cable management elements is moveable with the fiber management tray upon deformation.

16. The fiber management tray of claim 12, wherein when the flex mechanism of the fiber management tray is actuated generally in a first direction, the over-the-center action is created to move the cable management elements to the open position.

17. The fiber management tray of claim 12, wherein when the flex mechanism of the fiber management tray is actuated generally in a second direction, the over-the-center action is created to move the cable management elements to the closed position.

18. The fiber management tray of claim 12, wherein the multi-stable flexible base of the fiber management tray defines an opening that extends from a first end of the multi-stable flexible base toward a second end of the multi-stable flexible base.

19. The fiber management tray of claim 18, further comprising a sidewall positioned in the opening of the multi-stable flexible base to define a side of the opening, the sidewall extending upwardly from a portion of the multi-stable flexible base along the opening defined by the first and second ends of the multi-stable flexible base.

20. The fiber management tray of claim 19, wherein the sidewall includes a mechanical coupling interface to couple the fiber management tray to a structure.
